(19) United States
(12) Patent Application Publication
(10) Pub. No.: US 2025/0113790 A1
(43) Pub. Date: Apr. 10, 2025

(54) SYSTEM AND METHOD FOR RISK-BASED MANAGEMENT OF IRRIGATION

(71) Applicant: NAVE ANALYTICS, INC., Lincoln, NE (US)

(72) Inventors: Val Kovalsky, Lincoln, NE (US); Erik Boren, Kingston, WA (US)

(21) Appl. No.: 18/908,470

(22) Filed: Oct. 7, 2024

Related U.S. Application Data
(60) Provisional application No. 63/542,621, filed on Oct. 5, 2023.

(51) Int. Cl. A01G 25/16; G06N 7/00

(52) U.S. Cl. CPC A01G 25/167; G06N 7/00

(57) ABSTRACT

A system for risk-based management of irrigation may perform an initial assimilation for a first layer of soil, wherein the initial assimilation for the first layer of the soil is based on water input data and an initial water withdrawal estimate. The system may perform a deterministic-based estimate to generate deterministic-based estimate values for one or more additional layers of the soil. The system may perform an observation-based estimate to generate observation-based estimate values for the one or more additional layers of the soil. The system may generate soil moisture content modelling values based on the observation-based estimate values and the deterministic-based estimate values, the soil moisture content modelling values generated by applying a reconciliation algorithm to reconcile conflict between the deterministic-based estimate values and the observation-based estimate values.

### CROSS-REFERENCE TO RELATED APPLICATIONS

The present application claims the benefit under 35 U.S.C 119 (e) of U.S. Provisional Application No. 63/542,621, filed Oct. 5, 2023, which is herein incorporated by reference in the entirety.

### BACKGROUND

Often it is desirable to monitor soil moisture levels to determine potential impacts on crop production, such that decision-makers may determine how to manage irrigation. Existing techniques utilize probe-based methods to measure the soil moisture levels, however, the probe data provided by such techniques only provide estimates of soil moisture content and, therefore, is difficult to scale up to field level. Further, probes are costly to purchase, install, and maintain.

Additionally, some existing techniques utilize a deterministic-based estimation model, however, the existing deterministic-based estimation models have no mechanism to assimilate observations into the prior hydrological schemes. Further, not all of the deterministic models are distributed, hence they lack spatial details and context in produced insights. Additionally, deterministic models are rarely equipped with mechanisms to propagate and track uncertainty for each output variable throughout each time step and thus, cannot facilitate risk-based irrigation management.

Therefore, it would be desirable to provide a system and method that cures the shortfalls of the previous approaches identified above.

### SUMMARY

A system for risk-based irrigation management is disclosed, in accordance with one or more embodiments of the present disclosure. In some aspects, a risk-based irrigation system includes one or more platform servers including one or more processors configured to execute a set of program instructions stored in a memory, the one or more platform servers including a hydrology model stored in the memory, the set of program instructions configured to cause the one or more processors to: perform an initial assimilation for a first layer of soil, wherein the initial assimilation for the first layer of the soil is based on water input data and an initial water withdrawal estimate; perform one or more deterministic-based estimates to generate one or more deterministic-based estimate values for one or more additional layers of the soil; perform one or more observation-based estimates to generate one or more observation-based estimate values for the one or more additional layers of the soil; and generate one or more soil moisture content modelling values based on the one or more observation-based estimate values and the one or more deterministic-based estimate values, the one or more soil moisture content modelling values generated by applying a reconciliation algorithm to reconcile conflict between the one or more deterministic-based estimate values and the one or more observation-based estimate values.

A method of risk-based irrigation management is disclosed, in accordance with one or more embodiments of the present disclosure. In some aspects, a method for risk-includes performing an initial assimilation for a first layer of soil, wherein the initial assimilation for the first layer of the soil is based on water input data and initial water withdrawal estimate; performing one or more deterministic-based estimates to generate one or more deterministic-based estimate values for one or more additional layers of the soil; performing one or more observation-based estimates to generate one or more observation-based estimate values for the one or more additional layers of the soil; and generating one or more soil moisture content modelling values based on the one or more observation-based estimate values and the one or more deterministic-based estimate values, the one or more soil moisture content modelling values generated by applying a reconciliation algorithm to reconcile conflict between the one or more deterministic-based estimate values and the one or more observation-based estimate values.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1 illustrates a simplified block diagram of a risk-based irrigation management system, in accordance with one or more embodiments of the present disclosure.

FIG. 2 illustrates a flow chart depicting a method for performing risk-based irrigation management, in accordance with one or more embodiments of the present disclosure.

FIG. 3 illustrates a simplified block diagram of a hydrology model of the risk-based irrigation management system, in accordance with one or more embodiments of the present disclosure.

FIG. 4 illustrates a simplified block diagram of the method for performing risk-based irrigation management using the hydrology model, in accordance with one or more embodiments of the present disclosure.

FIG. 5. Illustrates a set of data graphs depicting inputs and outputs of the assimilation step of the method of performing risk-based irrigation management, in accordance with one or more embodiments of the present disclosure.

FIG. 6 illustrates a set of data graphs depicting outputs according to deterministic-based estimation step of the method of performing risk-based irrigation management, in accordance with one or more embodiments of the present disclosure.

FIG. 7 Illustrates a set of data graphs depicting outputs according to the observation-based estimation step of the method of performing risk-based irrigation management, in accordance with one or more embodiments of the present disclosure.

FIG. 8 Illustrates a set of data graphs depicting outputs according to the fusion step of the method of performing risk-based irrigation management, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Often it is desirable to monitor soil moisture levels to determine potential impacts on crop production, such that decision-makers may determine how to manage irrigation. Existing techniques utilize probe-based methods to measure soil moisture levels. For example, the gravimetric method is a probe-based technique used to measure soil moisture content by taking a soil sample, typically using a soil auger, weighing the sample, drying the sample in an oven to remove all moisture, and then reweighing the sample. The difference in weight before and after drying provides the moisture content as a percentage of the soil's dry weight. By way of another example, Time Domain Reflectometry (TDR) is a probe-based electromagnetic technique that measures soil moisture by sending electromagnetic pulses down a probe inserted into the soil. The travel time of the pulses is related to the dielectric constant of the soil, which in turn is influenced by soil moisture content. TDR sensors are capable of providing continuous and real-time soil moisture data at various depths. By way of another example, capacitance sensors may be used as a probe-based electromagnetic soil moisture measurement method. The capacitance sensors work based on the principle that the dielectric constant of soil changes with moisture content. Capacitance sensors have probes or rods that are inserted into the soil, and they measure the capacitance between the probe and the surrounding soil to estimate moisture content. By way of another example, a Neutron Probe (e.g., Neutron Moisture Meter) may be used to measure soil moisture indirectly by measuring the neutron scattering or absorption in the soil. A radioactive source emits neutrons into the soil, where the number of neutrons detected by the probe is related to soil moisture content. The Neutron Probe method is highly accurate but involves the use of radioactive materials, which may require special permits and precautions. It is contemplated that the probe data provided by the above techniques only provide estimates of soil moisture content and are, therefore, difficult to scale up to field level. Further, probes are costly to purchase, install, and maintain.

Additionally, some existing techniques utilize either a deterministic-based estimation model or an observation-based estimation model. Existing deterministic-based estimation models (e.g., HYDRUS, Soil and Water Assessment Tool (SWAT), Modular Groundwater Flow (MODFLOW), and the like) have no mechanism to assimilate observations into the prior hydrological schemes. Further, not all of the existing deterministic models are distributed, hence they lack spatial details and context in produced insights. Additionally, deterministic models are rarely equipped with mechanisms to propagate and track uncertainty for each output variable throughout each time step and thus, cannot facilitate risk-based irrigation management. As such, there is a need for a risk-based irrigation management system and method that cures the shortfalls of the previous approaches identified above.

Reference will now be made in detail to the subject matter disclosed, which is illustrated in the accompanying drawings.

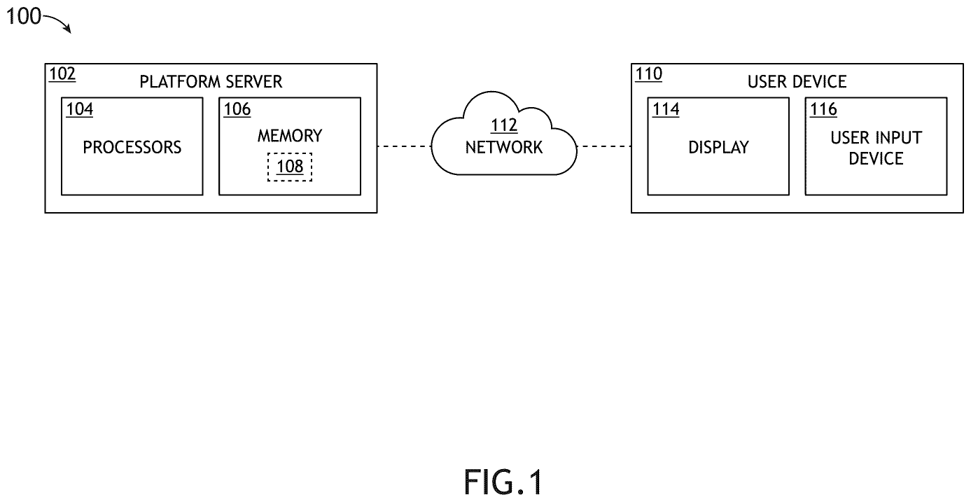

Referring generally to FIGS. 1-4, a system and method for risk-based management of irrigation is described, in accordance with one or more embodiments of the present disclosure.

Embodiments of the present disclosure are directed to a system and method for risk-based management of irrigation. In particular, embodiments of the present disclosure are directed to a system and method for risk-based management of irrigation in row crop agricultural production settings to optimize the allocation, use, and conservation of soil water, while considering uncertainties and potential impacts on crop production, thus providing decision-makers with scientific insights to make informed choices regarding short term and long-term irrigation management.

As previously discussed herein, existing techniques utilize either an observation-based or deterministic-based estimation technique. It is noted herein that the respective techniques are premised on conflicting principles and thus provide conflicting data, as such it is difficult to perform both techniques together. However, the system and method of the present disclosure utilizes a hydrology model without the use of in-ground sensors (or probes), where the hydrology model may simultaneously perform both observation-based estimation and deterministic-based estimation to provide soil moisture content data. The system and method of the present disclosure is configured to fuse together the conflicting data of the observation-based estimation and the deterministic-based estimation to generate soil moisture content data at various depths. For example, the hydrology model may include an error propagation framework and real-time observation assimilation capability. Further, the system and method of the present disclosure uses an exponential filter with other data assimilation technologies to produce fused estimates of soil moisture along with the risk of error in the estimate. As such, the system and method of the present disclosure is able to address risks related to information uncertainties, maintain adequacy of predictions, and ensure coherence of derived insights with physical reality and laws of hydrology in a practical manner.

It is contemplated that the system and method may provide a number of advantages over the soil probed-based methods of soil water tracking previously discussed above. For example, there is no hardware installation or maintenance costs to operate. Further, the system and method of the present disclosure is easily deployed and scaled to produce spatially explicit estimates of soil moisture at various depths.

As previously discussed herein, the existing techniques fail to track propagation of uncertainty. The system and method of the present disclosure provides a propagation of uncertainty of tracked variables throughout the processes of the model. The tracking of uncertainty enables soil moisture observation assimilation into each of the soil layers of the hydrology model in a spatially explicit manner. In this regard, the uncertainty feature of the present disclosure enables risk-based irrigation management insights that enhance sustainability of irrigation operations.

FIG. 1 illustrates a simplified block diagram of the risk-based irrigation management system 100, in accordance with one or more embodiments of the present disclosure.

In embodiments, the risk-based irrigation management system 100 includes one or more platform servers 102. The one or more platform servers 102 may include one or more processors 104 configured to execute program instructions maintained on a memory medium 106. In this regard, the one or more processors 104 of the one or more platform servers 102 may execute any of the various process steps described throughout the present disclosure. For example, the one or more processors 104 may be configured to generate soil moisture content data based on a hydrology model 108 stored in memory 106. The hydrology model 108 may simultaneously perform observation-based estimates and deterministic-based estimates to generate soil moisture content data. In this regard, the hydrology model 108 may use the results of the observation-based estimates to monitor the results of the deterministic-based estimates (and vice versa), where any discrepancies between the observation-based estimates and the deterministic-based estimates may be used to adjust (or correct) the hydrology model 108.

In embodiments, the one or more platform servers 102 may be communicatively coupled to one or more user devices 110 via the network 112. For example, the one or more platform servers 102 and/or the one or more user devices 110 may include a network interface device and/or the communication circuitry suitable for interfacing with the network 112.

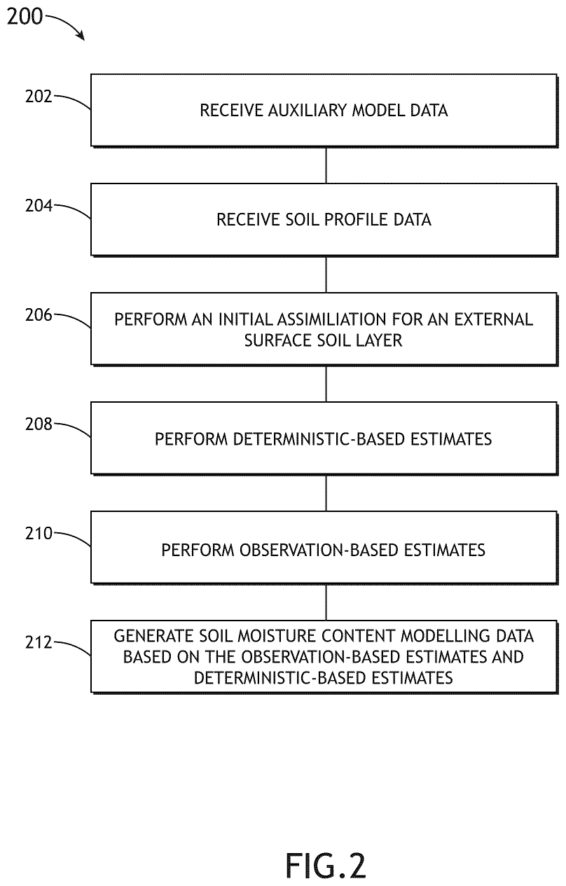

The various steps and functions carried out by the one or more processors 104 may be further understood with reference to FIGS. 2-4. Furthermore, any functions and/or steps shown and described as being carried out by processors of the user devices 110 may additionally and/or alternatively be carried out by the one or more processors 104 of the server 102.

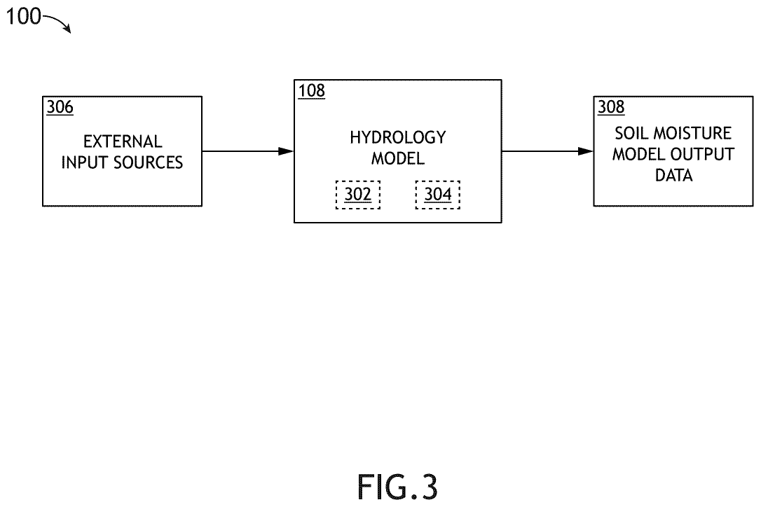

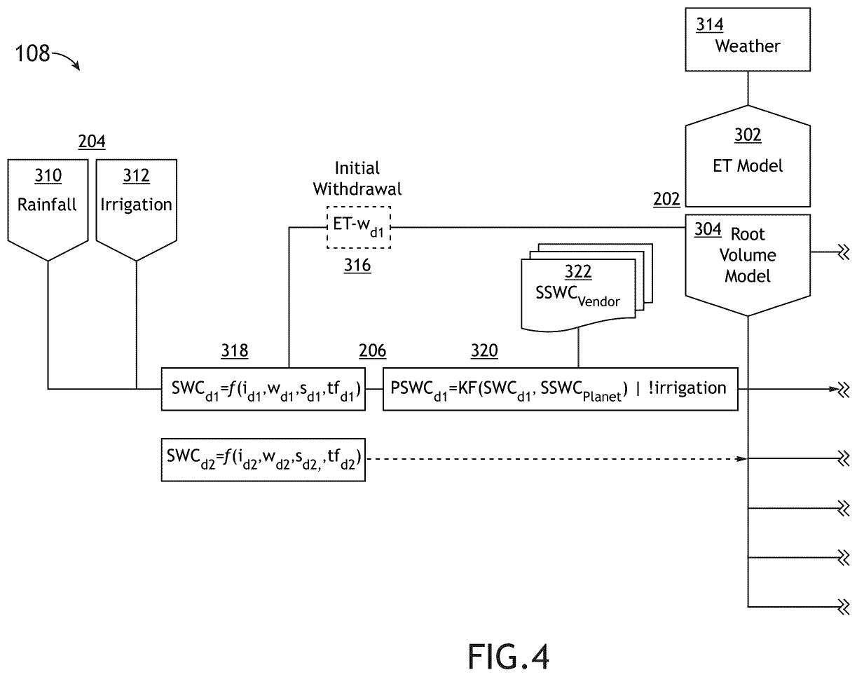

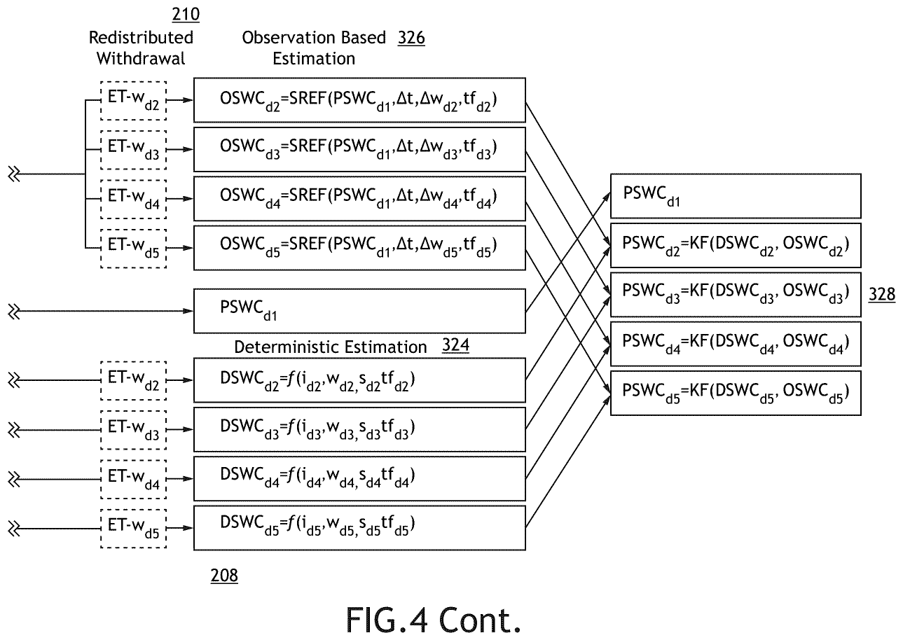

FIG. 2 is a flowchart of a method 200 for performing risk-based irrigation management using the hydrology model 108, in accordance with one or more embodiments of the present disclosure. FIG. 3 is a simplified block diagram of the hydrology model 108 stored in memory 106 of the one or more platform servers 102, in accordance with one or more embodiments of the present disclosure. FIG. 4 is a simplified block diagram of the method 200 for performing risk-based irrigation management using the hydrology model 108, in accordance with one or more embodiments of the present disclosure. It is noted herein that the steps of method 200 may be implemented all or in part by system 100. It is further recognized, however, that the method 200 is not limited to the system 100 in that additional or alternative system-level embodiments may carry out all or part of the steps of method 200.

In embodiments, the hydrology model 108 includes a distributed soil hydrology model 108. For example, the hydrology model 108 may perform soil analysis based on a soil grid. For instance, the soil grid of the hydrology model 108 may be arranged in grid cells or pixels, where the hydrology model 108 may be arranged in geographic coordinate space. In a non-limiting example, the size of the pixels may be approximately 0.0008889 degrees and have a grid dimension corresponding to approximately 100×100 meters.

In embodiments, the system 100 is configured to generate soil moisture content data 308 using the hydrology model 108. For example, the hydrology model 108 may be configured to simultaneously perform both observation-based estimation and deterministic-based estimation to provide soil moisture content data. For instance, as discussed further herein, the hydrology model 108 may be configured to fuse together the conflicting data of the observation-based estimation and the deterministic-based estimation to generate soil moisture content data at various depths. In this regard, the hydrology model 108 may include an error propagation framework and real-time observation assimilation capability.

It is contemplated that the system 100 may be configured to generate soil moisture content for any interval of time and at any variety of depths. In a non-limiting example, the system 100 may be configured to generate daily estimates of soil moisture content for five depths (e.g., 0-5 cm, 5-15 cm, 15-30 cm, 30-60 cm, 60-100 cm) of soil.

The goal of the soil texture parameterization is to define saturation, field holding capacity, wilting point, and saturated hydraulic conductivity (Ksat) for each soil depth layer. In the deterministic hydrological process model, these soil attributes are used as inputs to calculate the initial (t=0) soil water content, the rate of infiltration, seepage, runoff, and withdrawal of water from each soil layer.

At a minimum, the system 100 determines estimates of clay (% weight), silt (% weight), sand (% weight), and organic matter (% weight) for each soil layer depth. Using the four aforementioned soil properties as inputs, the system 100 may initialize the required soil water attributes listed above for each layer using a set of Saxton equations.

In a step 202, auxiliary model data may be received. For example, the one or more platform servers 102 may be configured to receive auxiliary model data from one or more auxiliary models.

In embodiments, the hydrology model 108 may include (or be communicatively coupled to) one or more auxiliary models. For example, the hydrology model 108 may include (or be communicatively coupled to) one or more evapotranspiration (ET) models 302. In this regard, the one or more evapotranspiration models 302 may be configured to provide evapotranspiration data to the hydrology model 108, such that the hydrology model 108 may be configured to account for how water is transferred from the land surface to the atmosphere via evaporation (i.e., how the water leaves the soil) and transpiration (i.e., how the water is lost through the plant).

By way of another example, the hydrology model 108 may include (or be communicatively coupled to) one or more root volume models 304. In this regard, the one or more root volume models 304 may be configured to provide root system data to the hydrology model 108, such that the hydrology model 108 may be configured to account for one or more characteristics of the crop roots.

It is contemplated that the evapotranspiration model 302 may be either general or crop-specific and be configured to provide periodic (e.g., daily, weekly, monthly, quarterly, yearly, or the like) estimates of evapotranspiration. Further, it is contemplated that the root volume model may be general or crop-specific and may be configured to provide periodic (e.g., daily, weekly, monthly, quarterly, yearly, or the like) estimates of root zone depth, root zone volume, or the like at predetermined soil depths.

In a step 204, soil profile data may be received. For example, the one or more platform servers 102 may be configured to receive soil profile data from one or more external input sources 306. In one instance, the soil profile data may be received manually via the user input device 116 of the user device 110. In another instance, the soil profile data may be received automatically via one or more application program interfaces (APIs). It is contemplated that the soil profile data may be received from any source (e.g., remote database or internal database).

The soil profile data may include, but is not limited to, rainfall data (e.g., daily rainfall data, weekly rainfall data, monthly rainfall data, and the like), irrigation data (e.g., daily irrigation data, weekly irrigation data, monthly irrigation data, and the like), weather data (e.g., temperature, solar radiation, wind speed, relative humidity, and the like), and the like.

For example, in a non-limiting example, the hydrology model 108 may be configured to receive rainfall data 310. For instance, the rainfall data 310 may include periodic (e.g., daily, weekly, monthly, or the like) rainfall records coming in field level or spatially explicit manner and measured in height of water level in a gauge (e.g., liter/meter squared or inch/acre). In this regard, the hydrology model 108 may be configured to account for periodic rainfall measurements when determining the soil moisture content.

By way of another example, in a non-limiting example, the hydrology model 108 may be configured to receive irrigation data 312. For instance, the irrigation data 312 may include periodic (e.g., daily, weekly, monthly, or the like) irrigation records collected by automated equipment or service personnel applied on a field level or spatially explicit manner and measured in height of water level in a gauge (e.g., liter/meter squared or inch/acre). In this regard, the hydrology model 108 may be configured to account for periodic irrigation measurements when determining the soil moisture content.

It is contemplated that to enter the processing flow, the telemetry records, irrigation, and/or rainfall data may be transformed into rasterized surfaces. For example, the system 100 may be configured to perform basic transformations to standardize the non-standard input data into rasterized surfaces. For instance, the system 100 may be configured to perform specific procedures that convert flow measurements, pressure controller records, pump telemetry, and other data that requires customized conversion into standardized rasters.

By way of another example, in a non-limiting example, the evapotranspiration model 302 may be configured to receive weather data 314. For instance, the weather data 314 may be used by the evapotranspiration model 302, such that the evapotranspiration model 302 may be configured to account for weather data when determining evapotranspiration of the water from crops.

In a non-limiting example, the weather data may include periodic (e.g., daily, weekly, monthly, or the like) temperature data, where the periodic temperature day includes periodic maximum and minimum air temperatures (e.g., in degrees Celsius). It is noted that the temperatures influence the potential evapotranspiration and are crucial for estimating the energy available for evaporation and transpiration.

In a non-limiting example, the weather data may include periodic (e.g., daily, weekly, monthly, or the like) solar radiation data, where the periodic solar radiation data includes periodic solar radiation or sunshine hours (e.g., in joules per square meter or hours). It is noted that the solar radiation data may represent the energy available for the evaporation and transpiration processes.

In a non-limiting example, the weather data may include periodic (e.g., daily, weekly, monthly, or the like) wind speed data (e.g., in meters per second). It is noted that wind speed may affect the rate of evaporation by controlling the transfer of moisture from the surface.

In a non-limiting example, the weather data may include periodic (e.g., daily, weekly, monthly, or the like) relative humidity data, where the periodic relative humidity data includes the average relative humidity (e.g., as a percentage). It is noted that the relative humidity data may indicate the moisture content of the air and influence the evaporative demand.

In a step 206, an initial assimilation of the external surface soil moisture is performed to determine a post-assimilation soil water content at a first layer. In a non-limiting example, the initial assimilation of the external surface soil moisture may be performed based on the top layer of the soil (e.g., first 5 cm of soil), where the soil moisture content at the top layer begins with the deterministic water balance-based estimation along with infiltration down into the layer below.

In embodiments, the system 100 is configured to perform the initial assimilation of the external surface soil moisture based on the received soil profile data and the auxiliary model data. For example, the one or more platform servers 102, via the hydrology model 108, may be configured to perform an initial assimilation of the external surface soil moisture based on the received soil profile data and the auxiliary model data.

In embodiments, the hydrology model 108 is configured to estimate an initial withdrawal ET_{W}_{_{d1}} 316 at a first depth d₁. For example, the hydrology model 108 may be configured to perform the initial estimated withdrawal 316 at the first depth based on the evapotranspiration data from the one or more evapotranspiration models 302 and the one or more root volume models 304. For instance, the water lost through evapotranspiration is estimated based on the root zone model partition of the estimated periodic (e.g., daily, weekly, monthly, or the like) evapotranspiration.

In embodiments, the hydrology model 108 is configured to determine a soil water content SWC_{d1} 318 at the first depth based on the estimated initial withdrawal ET_{W}_{_{d1}} 316 at the first depth d₁. For example, the hydrology model 108 may be configured to determine the soil water content SWC_{d1} 318 at the first depth using Equation 1, as shown and described below:

$$S W {C}_{d 1} = f ( {i}_{d 1} , {w}_{d 1} , {s}_{d 1} , t {f}_{d 1} ) \qquad Equation l$$

where SWC_{d1} is the soil water content at the first layer (or depth), i_{d1} is the infiltration at the first layer, w_{d1} is the withdrawal at the first layer, s_{d1} is the seepage at the first layer, and tf_{d1} is the texture factor at the first layer.

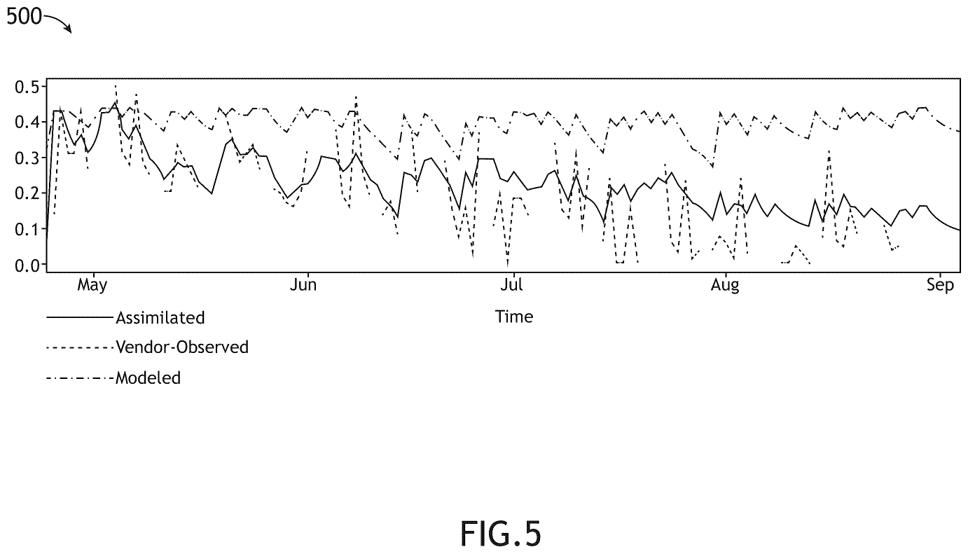

In embodiments, the system 100 is configured to determine a post-assimilation soil water content PSWC_{d1} 320. For example, the hydrology model 108 may be configured to determine a post-assimilation soil water content PSWC_{d1} 320 at the first depth by performing the initial assimilation (or initial estimate), mixing the initial assimilation with observations, and correcting for water input via irrigation/rainfall. For instance, the hydrology model 108 may be configured to determine the post-assimilation soil water content PSWC_{d1} at the first depth using Equation 2, as shown and described below:

$$P S W {C}_{d 1} = K F ( S W {C}_{d 1} , S S W {C}_{P l anet} ) \vert irrigation \qquad Equation 2$$

where PSWC_{d1} is the post-assimilation soil water content at the first layer (or first depth), SWC_{d1} is the soil water content at the first layer, SSWC_{Planet} is the soil water content observations of the first layer, | irrigation signifies contingency on irrigation built into KF which stands for Kalman filter. FIG. 5. Illustrates a set of data graphs 500 depicting inputs and outputs according to step 206. In this example, modelled and observed surface soil moisture content are transformed into assimilated surface soil moisture content. The x-axis depicts time and the y-axis depicts soil moisture content in m³/m³ as a function of time.

The determined soil water content at the first layer SWC_{d1} from the initial assimilation may be used to determine the post-assimilation soil water content at the first layer PSWC_{d1}. For example, as previously discussed herein, the initial assimilation may be based on deterministic estimates and the initial withdrawal from the one or more evapotranspiration models 302 and inputs.

Soil water content observations of the external surface soil (e.g., at the first layer) may be used to determine the post-assimilation soil water content at the first layer PSWC_{d1}. For example, the soil moisture content observations may include initial external soil surface observations 322. In a non-limiting example, the soil moisture content observations may be received from an external source (e.g., SSWC_{Vendor}). In this regard, observation-based estimates may be performed initially on the top layer of the soil.

The irrigation factorial may be used to determine the post-assimilation soil water content at the first layer PSWC_{d1}. For example, the irrigation factorial may be configured to account for the rainfall data and/or irrigation data received from external input sources 306. It is contemplated that the irrigation factorial may ensure that irrigation is corrected for correctly.

The Kalman Filter (KF) may be applied to reconcile any conflict between the observations and telemetry including in the deterministic portions. It is noted that the initial assimilation step is conditioned on presence of irrigation which augments the Kalman filter processing. It is contemplated that any type of non-parametric model (or algorithm) may be used to reconcile the conflict between the observation-based and deterministic-based initial estimates including, but not limited to, an Ensemble Kalman Filter, an Extended Kalman Filter, Cubature Kalman Filter, Hybrid Kalman Filter, Rauch-Tung-Striebel Smoother, or the like.

The uncertainty from both infiltration and withdrawal processes may be propagated in the deterministic balancing. When an external observation becomes available, the Kalman filter is deployed to update the model state and error using the external observation and associated error.

It is contemplated that once the post-assimilation soil moisture content for the top layer is determined, the determined post-assimilation soil moisture content for the top layer stays unchanged until the next modeling step. Further, it is contemplated that once the post-assimilation soil moisture content for the top layer is determined, the determined post-assimilation soil moisture content for the top layer triggers redistribution of withdrawal (ET_{W}_{_{d1}}) for the additional layers (e.g., depths d₂-d₅) based on the assimilated soil moisture content that affects the water availability for the root system partitioned withdrawal of the root volume model 304, as will be discussed further herein with respect to steps 208-210. It is noted that external surface soil moisture content may be ignored during time step t if irrigation water is being injected during time step t.

In a step 208, one or more deterministic-based estimates are performed to generate one or more deterministic soil water content values.

In embodiments, the system 100 is configured to perform one or more deterministic-based estimates for each soil layer. For example, the one or more platform servers 102, via the hydrology model 108, may be configured to perform one or more deterministic-based estimates 324 for each soil layer to generate one or more deterministic soil water content values for each soil layer.

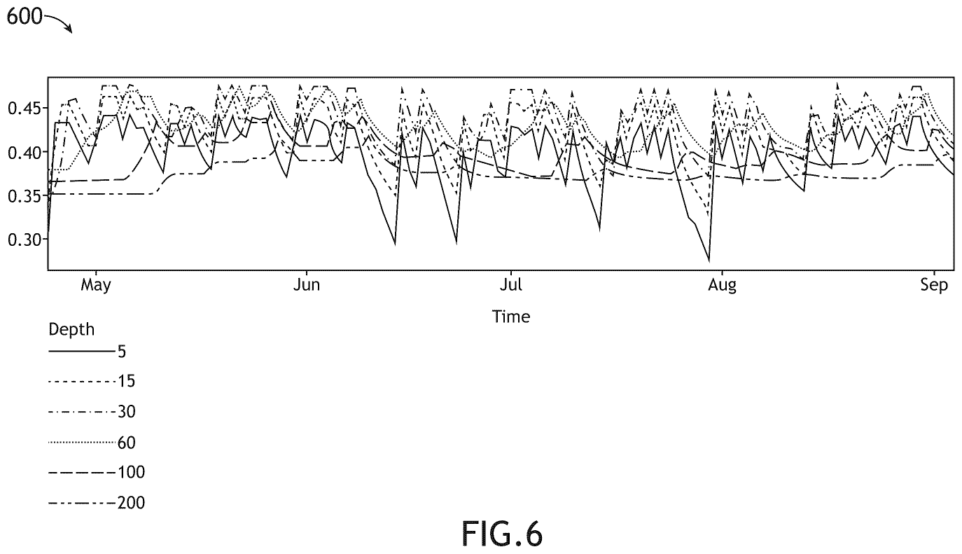

In embodiments, the one or more deterministic-based estimates are performed using a deterministic hydrological model based on the sum of four stepwise processes. For example, the four stepwise processes may include, but are not limited to, forward step water balance, injection, seepage, and withdrawal. It is contemplated that errors may be propagated from each of the deterministic water content inputs through each soil water calculation process and layer, resulting in an estimated error for each soil layer depth, as shown and described by Equations 3.1-3.4 below:

$$D S W {C}_{d 2} = f ( {i}_{d 2} , {w}_{d 2} , {s}_{d 2} , t {f}_{d 2} ) \qquad Equation 3.1$$

$$DSW {C}_{d 3} = f ( {i}_{d 3} , {w}_{d 3} , {s}_{d 3} , t {f}_{d 3} ) \qquad Equation 3.2$$

$$DSW {C}_{d 4} = f ( {i}_{d 4} , {w}_{d 4} , {s}_{d 4} , t {f}_{d 4} ) \qquad Equation 3.3$$

$$DSW {C}_{d 5} = f ( {i}_{d 5} , {w}_{d 5} , {s}_{d 5} , t {f}_{d 5} ) \qquad Equation 3.4$$

where DSWC_{dn} is the deterministic-based soil water content at the Nth layer (or depth), i_{dn} is the infiltration at the Nth layer, w_{dn} is the withdrawal at the Nth layer, San IS the seepage at the Nth layer, tf_{dn} is the texture factor at the Nth layer, and n is an integer between 2-n corresponding to the respective soil layer (e.g., second layer, third layer, fourth layer, fifth layer, and the like). FIG. 6 illustrates a set of data graphs 600 depicting outputs according to step 208. In this example, deterministically modelled soil moisture content at multiple depths is depicted. The x-axis depicts time and the y-axis depicts soil moisture content in m³/m³. The various depths (in the legend) are provided in centimeters. Soil moisture content is modelled at depths of 5, 15, 30, 60, 100, and 200 centimeters.

The four stepwise processes may be described in more detail below.

For example, the Forward step water balance process may include initializing the deterministic model at each new step (e.g., day, week, month, or the like) through a set of calculations to move previously estimated seepages in each layer downward into the soil layer below based on their current soil water content and soil texture properties. This step also includes seepage of water out of the bottom soil layer (e.g., secretion of water out of the soil column). It is noted that the seepage of the previous meddling cycles becomes infiltration in the below layer of the next cycle.

By way of another example, the injection process (e.g., Precipitation and Irrigation Injection process) may account for the process of injecting water into the system via precipitation and irrigation injection. For instance, after the initial water balance step, the total amount of water from rainfall and irrigation is injected into the top three layers of soil partitioned proportionally to the depth. If excess precipitation or irrigation is encountered, then the remainder is carried through for the post-seepage injection. If excess persists after the post-seepage injection, the remainder is discarded into runoff.

By way of another example, the Seepage process may be needed to prepare the next step infiltration. For instance, after infiltration is complete, injection of the remaining incoming water may be done in the top three soil layers, and infiltration is calculated once more. Any remaining incoming water that was not injected into the top three soil layers is considered runoff.

By way of another example, the Withdrawal process accounts for moisture content loss in the soil layers in response to evaporative demand modulated by depth and presence of root volume in the layer. For instance, the Root system model is executed first to distribute ET amongst the layers through a series of trapezoidal calculations. Further, the system 100 approximates the water lift potential of the root system in each layer. Redistributed ET withdrawal is then adjusted in accordance with water lift potential and available moisture content.

In a step 210, one or more observation-based estimates are performed to generate one or more observation soil water content values.

In embodiments, the system 100 is configured to perform one or more observation-based estimates for each soil layer. For example, the one or more platform servers 102, via the hydrology model 108, may be configured to perform one or more observation-based estimates for each soil layer to generate one or more observation soil water content values 326.

It is noted that the principle of observation of soil moisture modeling may focus on capturing time lags and magnitude adjustments that are observable between soil moisture content observations at different measurement depth.

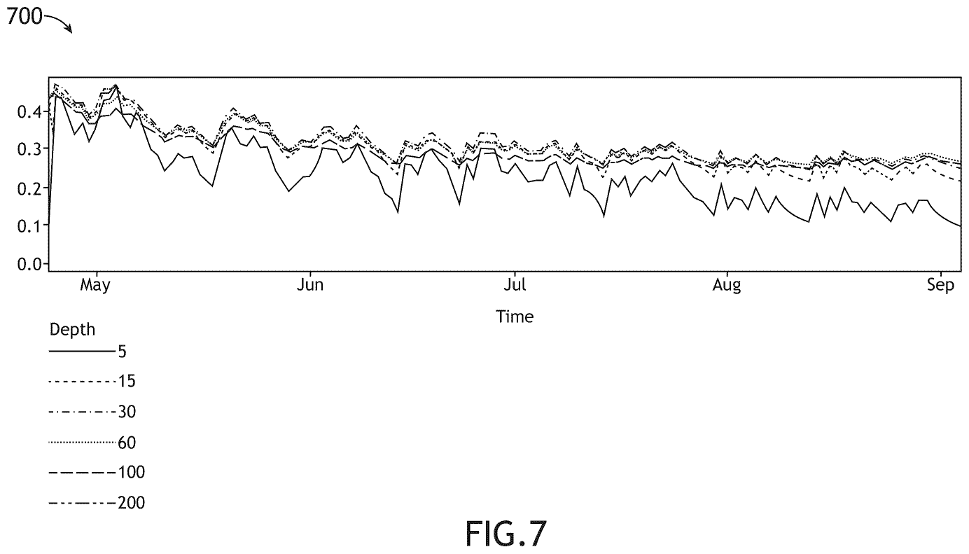

In embodiments, the hydrology model 108 is configured to apply a Surrogate Exponential Filter (SREF) to generate the one or more observation soil water content values 326. It is contemplated that the key controlling factor in exponential filtering for soil moisture modeling constitutes soil texture that controls movement of water down the profile. The Surrogate Exponential Filter of the present disclosure is configured to add water withdrawals as a factor controlling time lags and magnitude relationships in the exponential filter formulations, as shown and described by Equations 4.1-4.4 below.

$$OSW {C}_{d 2} = S R E F ( P S W {C}_{d 1} , Δ t , Δ {w}_{d 2} , t {f}_{d 2} ) \qquad Equation 4.1$$

$${OSWC}_{d 3} = S R E F ( P S W {C}_{d 1} , Δ t , Δ {w}_{d 3} , t {f}_{d 3} ) \qquad Equation 4.2$$

$${OSWC}_{d 4} = S R E F ( P S W {C}_{d 1} , Δ t , Δ {w}_{d 4} , t {f}_{d 4} ) \qquad Equation 4.3$$

$${OSWC}_{d 5} = S R E F ( P S W {C}_{d 1} , Δ t , Δ {w}_{d 5} , t {f}_{d 5} ) \qquad Equation 4.4$$

where OSWC_{dn} is the observation-based soil water content at the Nth layer (or depth), PSWC_{d1} is the post-assimilate soil water content at the first layer, Δt is the time elapsed, Awan is the water withdrawn over time at the Nth layer, tf_{dn} is the texture factor at the Nth layer, and n is an integer between 2-n corresponding to the respective soil layer (e.g., second layer, third layer, fourth layer, fifth layer, and the like). FIG. 7 Illustrates a set of data graphs 700 depicting outputs according to step 210. In this example, observation-based estimates of soil moisture content at multiple depths is depicted. The x-axis depicts time and the y-axis depicts soil moisture content in m³/m³. The various depths (in the legend) are provided in centimeters. Soil moisture content is acquired at depths of 5, 15, 30, 60, 100, and 200 centimeters.

It is noted that uncertainty propagation procedures may be built in to make the results amenable to further real time data assimilation. In a non-limiting example, the surrogate exponential filter may be applied only to the layers below the top 5 cm. It is contemplated that the top layer may be used to drive the module with the parameterization needed for corresponding soil profile depth.

In a step 212, the observation-based estimates and the deterministic-based estimates are combined to generate soil moisture content modelling data.

In embodiments, the system 100 may be configured to perform a fusion of layered soil moisture content estimates from the deterministic-based and observation-based values. For example, as previously discussed herein, the deterministic-based and observation-based estimates produce conflicting data that is of the same type. In this regard, the system 100 needs to de-conflict the data in a way such that the system 100 does not encounter conflict.

It is contemplated that the fusion step (step 212) may be executed after both deterministic and observation-based estimates have been performed.

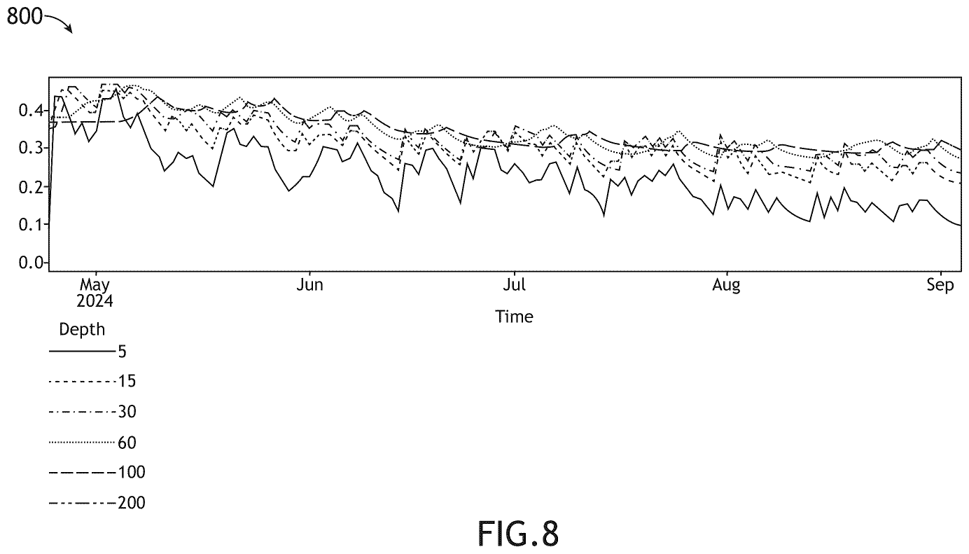

Similar to the initial assimilation step (e.g., for the top 5 cm) detailed above, the model state and propagated uncertainty from both the deterministic and Surrogate Exponential Filter modules (e.g., a set of four model states and uncertainties for each module) may be combined for assimilation using a Kalman Filter (KF), as shown and described by Equations 5.1-5.4 below:

$$P S W {C}_{d 2} = K F ( D S W {C}_{d 2} , OSW {C}_{d 2} ) \qquad Equation 5.1$$

$$PSW {C}_{d 3} = K F ( D S W {C}_{d 3} , OSW {C}_{d 3} ) \qquad Equation 5.2$$

$$PSW {C}_{d 4} = K F ( D S W {C}_{d 4} , OSW {C}_{d 4} ) \qquad Equation 5.3$$

$$PSW {C}_{d 5} = K F ( D S W {C}_{d 5} , OSW {C}_{d 5} ) \qquad Equation 5.4$$

where PSWC_{dn} is the post-assimilation soil water content at the Nth layer, KF stands for Kalman Filter, OSW Can is the observation-based soil water content at the Nth layer (or depth), DSWC_{dn} is the observation-based soil water content at the Nth layer (or depth), and n is an integer between 2-n corresponding to the respective soil layer (e.g., second layer, third layer, fourth layer, fifth layer, and the like). FIG. 8 Illustrates a set of data graphs 800 depicting outputs according to step 212. In this example, observation-based estimates of soil moisture content at multiple depths is depicted. The x-axis depicts time and the y-axis depicts soil moisture content in m³/m³. The various depths (in the legend) are provided in centimeters. Soil moisture content is acquired at depths of 5, 15, 30, 60, 100, and 200 centimeters

The output of the final Kalman Filter fusion may include new reconciled model states and uncertainties for each soil depth below the top layer (e.g., top 5 cm layer).

It is contemplated that any type of non-parametric model (or algorithm) may be used to reconcile the conflict between the observation-based and deterministic-based estimates including, but not limited to, an Ensemble Kalman Filter, an Extended Kalman Filter, Cubature Kalman Filter, Hybrid Kalman Filter, Rauch-Tung-Striebel Smoother, or the like. In this regard, the non-parametric models (e.g., Kalman Filter, or the like) may be deployed to improve the accuracy of the system 100 and address non-linear effects in soil moisture dynamics, as well as adoption to non-normal distributions.

The post-assimilation soil water content (PSWC_{dn}) values 328, determined in step 212, may provide knowledge about how much water is actually available for crop consumption. In this regard, the post-assimilation soil water content (PSWC_{dn}) values may help to determine the need for irrigation based on a risk-based irrigation management approach of the present disclosure.

Referring back to FIG. 1, in embodiments, the one or more processors 104 may include any one or more processing elements known in the art. In this sense, the one or more processors 104 may include any microprocessor-type device configured to execute software algorithms and/or instructions. For example, the one or more processors 104 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 104. In general, the term “processor” may be broadly defined to encompass any device having one or more processing elements, which execute program instructions from memory 106. Moreover, different subsystems of the system 100 (e.g., user device 110, network 112, server 102) may include processor or logic elements suitable for carrying out at least a portion of the steps described throughout the present disclosure. Therefore, the above description should not be interpreted as a limitation on the present disclosure but merely an illustration.

The memory 106 may include any storage medium known in the art suitable for storing program instructions executable by the associated one or more processors 104. For example, the memory 106 may include a non-transitory memory medium. For instance, the memory 106 may include, but is not limited to, a read-only memory (ROM), a random-access memory (RAM), a magnetic or optical memory device (e.g., disk), a solid-state drive, and the like. It is further noted that memory 106 may be housed in a common controller housing with the one or more processors 104. In an alternative embodiment, the memory 106 may be located remotely with respect to the physical location of the processors 104, user device 110, server 102, and the like. For instance, the one or more processors 104 and/or the server 102 may access a remote memory (e.g., server), accessible through a network (e.g., internet, intranet and the like). The memory 106 may also maintain program instructions for causing the one or more processors 104 to carry out the various steps described through the present disclosure.

The one or more platform servers 102 may receive information from other systems or sub-systems (e.g., a user device 110, one or more additional servers, and/or components of the one or more additional servers) communicatively coupled to the platform server 102 by a transmission medium that may include wireline and/or wireless portions. The server 102 may additionally transmit data or information to one or more systems or sub-systems communicatively coupled to the platform server 102 by a transmission medium that may include wireline and/or wireless portions. In this regard, the transmission medium may serve as a data link between the server 102 and the other systems or sub-systems (e.g., a user device 110, one or more additional servers, and/or components of the one or more additional servers) communicatively coupled to the server 102. Additionally, the server 102 may be configured to send data to external systems via a transmission medium (e.g., network connection).

The communication circuitry of the user device 110 may include any network interface circuitry or network interface device suitable for interfacing with network 112. For example, the communication circuitry may include wireline-based interface devices (e.g., DSL-based interconnection, cable-based interconnection, T9-based interconnection, and the like). In embodiments, the communication circuitry may include a wireless-based interface device employing GSM, GPRS, CDMA, EV-DO, EDGE, WiMAX, 3G, 4G, 4G LTE, 5G, Wi-Fi protocols, RF, LoRa, and the like.

In embodiment, the one or more user devices 110 may be configured to receive one or more user inputs from a user. For example, the one or more user devices 110 may include a user interface, wherein the user interface includes a display 114 and a user input device 116. The one or more processors 104 may be configured to generate the graphical user interface of the display 114, wherein the graphical user interface includes the one or more display pages configured to transmit and receive data to and from a user.

The display 114 may be configured to display various selectable buttons, selectable elements, text boxes, and the like, in order to carry out the various steps of the present disclosure. In this regard, the user device 110 may include any user device known in the art for displaying data to a user including, but not limited to, mobile computing devices (e.g., smart phones, tablets, smart watches, and the like), laptop computing devices, desktop computing devices, and the like. By way of another example, the user device 110 may include one or more touchscreen-enabled devices. In embodiments, the display 114 includes a graphical user interface, wherein the graphical user interface includes one or more display pages configured to display and receive data/information to and from a user. The display 114 may include any display device known in the art. For example, the display 114 may include, but is not limited to, a liquid crystal display (LCD), an organic light-emitting diode (OLED) based display, a CRT display, and the like.

The user input device 116 may be coupled with the display 114 by a transmission medium that may include wireline and/or wireless portions. The user input device 116 may include any user input device known in the art. For example, the user input device 116 may include, but is not limited to, a keyboard, a keypad, a touchscreen, a lever, a knob, a scroll wheel, a track ball, a switch, a dial, a sliding bar, a scroll bar, a slide, a handle, a touch pad, a bezel input device or the like. In the case of a touchscreen interface, several touchscreen interfaces may be suitable. For instance, the display 114 may be integrated with a touchscreen interface, such as, but not limited to, a capacitive touchscreen, a resistive touchscreen, a surface acoustic based touchscreen, an infrared based touchscreen, or the like.

The communication circuitry of the server 102 may include any network interface circuitry or network interface device suitable for interfacing with network 112. For example, the communication circuitry may include wireline-based interface devices (e.g., DSL-based interconnection, cable-based interconnection, T9-based interconnection, and the like). In embodiments, the communication circuitry may include a wireless-based interface device employing GSM, GPRS, CDMA, EV-DO, EDGE, WiMAX, 3G, 4G, 4G LTE, 5G, Wi-Fi protocols, RF, LoRa, and the like.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A risk-based irrigation system, the risk-based irrigation system comprising:
one or more platform servers including one or more processors configured to execute a set of program instructions stored in a memory, the one or more platform servers including a hydrology model stored in the memory, the set of program instructions configured to cause the one or more processors to:
perform an initial assimilation for a first layer of soil, wherein the initial assimilation for the first layer of the soil is based on water input data and an initial water withdrawal estimate;
perform one or more deterministic-based estimates to generate one or more deterministic-based estimate values for one or more additional layers of the soil;
perform one or more observation-based estimates to generate one or more observation-based estimate values for the one or more additional layers of the soil; and
generate one or more soil moisture content modelling values based on the one or more observation-based estimate values and the one or more deterministic-based estimate values, the one or more soil moisture content modelling values generated by applying a reconciliation algorithm to reconcile conflict between the one or more deterministic-based estimate values and the one or more observation-based estimate values.

2. The system of claim 1, wherein the set of program instructions are further configured to cause the one or more processors to:
receive a set of auxiliary model data, wherein the set of auxiliary model data includes evapotranspiration data and root system data.

3. The system of claim 2, wherein the hydrology model is coupled to one or more evapotranspiration models.

4. The system of claim 2, wherein the hydrology model is coupled to one or more root volume models.

5. The system of claim 2, wherein the set of program instructions are further configured to cause the one or more processors to:
estimate the initial withdrawal for the first layer of the soil based on the received set of auxiliary model data.

6. The system of claim 1, wherein the set of program instructions are further configured to cause the one or more processors to:
receive a set of soil profile data from one or more external input sources, wherein the set of soil profile data may include the water input data.

7. The system of claim 1, wherein the water input data includes at least one of:
daily rainfall data or daily irrigation data.

8. The system of claim 1, wherein the hydrology model is arranged in a plurality of grid cells.

9. The system of claim 8, wherein the plurality of grid cells are 100 meters by 100 meters.

10. The system of claim 1, further comprising:
one or more user devices, wherein the one or more user devices include one or more displays and one or more user input devices.

11. The system of claim 10, wherein the one or more user devices are communicatively coupled the one or more platform servers via a network.

12. The system of claim 1, wherein the reconciliation algorithm includes at least one of:
a Kalman Filter, Ensemble Kalman Filter, an Extended Kalman Filter, a Hybrid Kalman Filter, or a Rach-Tung-Striebel Smoother.

13. A method for risk-based irrigation, the method for risk-based irrigation comprising:
performing an initial assimilation for a first layer of soil, wherein the initial assimilation for the first layer of the soil is based on water input data and initial water withdrawal estimate;
performing one or more deterministic-based estimates to generate one or more deterministic-based estimate values for one or more additional layers of the soil;
performing one or more observation-based estimates to generate one or more observation-based estimate values for the one or more additional layers of the soil; and
generating one or more soil moisture content modelling values based on the one or more observation-based estimate values and the one or more deterministic-based estimate values, the one or more soil moisture content modelling values generated by applying a reconciliation algorithm to reconcile conflict between the one or more deterministic-based estimate values and the one or more observation-based estimate values.

14. The method of claim 13, further comprising:
receiving a set of auxiliary model data, wherein the set of auxiliary model data includes evapotranspiration data and root system data.

15. The method of claim 13, further comprising:
estimating the initial withdrawal for the first layer of the soil based on the received set of auxiliary model data.

16. The method of claim 13, further comprising:
receiving a set of soil profile data from one or more external input sources, wherein the set of soil profile data may include the water input data.

17. The method of claim 13, wherein the hydrology model is coupled to one or more evapotranspiration models.

18. The method of claim 13, wherein the hydrology model is coupled to one or more root volume models.

19. The method of claim 13, wherein the water input data includes at least one of:
daily rainfall data or daily irrigation data.

20. The method of claim 13, wherein the reconciliation algorithm includes at least one of:
a Kalman Filter, Ensemble Kalman Filter, an Extended Kalman Filter, a Hybrid Kalman Filter, or a Rach-Tung-Striebel Smoother.
